(19) United States
(12) Patent Application Publication
(10) Pub. No.: US 2025/0036923 A1
(43) Pub. Date: Jan. 30, 2025

(54) SEMANTIC MULTI-RESOLUTION COMMUNICATIONS

(71) Applicant: NEC Laboratories America, Inc., Princeton, NJ (US)

(72) Inventors: Mohammad Khojastepour, Lawrenceville, NJ (US); Matin Mortaheb, College Park, MD (US); Srimat Chakradhar, Manalapan, NJ (US)

(21) Appl. No.: 18/782,792

(22) Filed: Jul. 24, 2024

Related U.S. Application Data
(60) Provisional application No. 63/528,470, filed on Jul. 24, 2023.

(51) Int. Cl. G06N 3/0455; G06N 3/08

(52) U.S. Cl. CPC G06N 3/0455; G06N 3/08

(57) ABSTRACT

Methods and systems for semantic multi-resolution transmission include encoding data using an encoder model that includes an initial encoding and heads. A first head of outputs a base encoding and a remainder of the heads output respective enhancement encodings. The base encoding and at least one of the enhancement encodings are decoded using a decoder model to retrieve the semantic meaning of the data and to generate a reconstructed output. A task is performed responsive to the reconstructed output and retrieved semantic meaning.

### RELATED APPLICATION INFORMATION

This application claims priority to U.S. Patent Application No. 63/528,470, filed on Jul. 24, 2023, incorporated herein by reference in its entirety.

### BACKGROUND

### Technical Field

The present invention relates to joint source-channel coding and, more particularly, to semantic multi-resolution communications.

### Description of the Related Art

Communications systems that separately optimize source and channel coding can mitigate the effects of noise and interference on a communication channel, but this is not optimal for finite block lengths and multi-user scenarios. Joint source and channel coding can provide improvements over separate source-channel coding, for example in scenarios where channel coding rate is limited to support the user with the worst channel. Joint source-channel coding can sacrifice some amount of reconstruction performance on weaker channels to provide significant performance improvements on stronger channels.

### SUMMARY

A method for semantic multi-resolution transmission includes encoding data using an encoder model that includes an initial encoding and heads. A first head of outputs a base encoding and a remainder of the heads output respective enhancement encodings. The base encoding and at least one of the enhancement encodings are decoded using a decoder model to retrieve the semantic meaning of the data and to generate a reconstructed output. A task is performed responsive to the reconstructed output and retrieved semantic meaning.

A system for multi-resolution transmission includes a hardware processor and a memory that stores a computer program. When encoded by the hardware processor, the computer program causes the hardware processor to encode data using an encoder model that includes an initial encoding and heads. A first head outputs a base encoding and a remainder of the heads output respective enhancement encodings. The base encoding and at least one of the enhancement encodings are decoded using a decoder model to retrieve the semantic meaning of the data and to generate a reconstructed output. A task is performed responsive to the reconstructed output and retrieved semantic meaning.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of semantic multi-resolution transmission, in accordance with an embodiment of the present invention;

FIG. 2 is a block/flow diagram of semantic multi-resolution transmission, in accordance with an embodiment of the present invention;

FIG. 3 is a diagram illustrating an exemplary environment where semantic multi-resolution transmission can be used to handle data, in accordance with an embodiment of the present invention;

FIG. 4 is a block diagram of a computing device that can perform semantic multi-resolution encoding, in accordance with an embodiment of the present invention;

FIG. 5 is a diagram showing a neural network architecture that can be used as part of a semantic multi-resolution encoder, in accordance with an embodiment of the present invention; and

FIG. 6 is a diagram showing a deep neural network architecture that can be used as part of a semantic multi-resolution encoder, in accordance with an embodiment of the present invention.

### DETAILED DESCRIPTION OF PREFERRED EMBODIMENTS

Multi-resolution communications handles the transmission of information using different quality tiers, for example using a base tier that delivers a lowest level of quality and successively higher tiers that provide information to improve the quality of the base tier. Rather than re-encoding the media for each tier separately, multi-resolution encoding may provide differential data for the successive tiers that is applied to improve the quality of the base tier. In this manner, transmissions to users on channels of differing quality can include only those tiers which the channel will support.

In addition to providing successive refinement for tiered reconstruction performance, hierarchical semantic information can be preserved with finer accuracy through successive encoded outputs. In semantic communication, an intended meaning is preserved in the encoded data, which may then be compressed to satisfy reconstruction performance requirements. Semantic multi-resolution communication may encode multiple sub-blocks, where each sub-block provides further information to a decoder to improve reconstruction performance and/or improve the accuracy of a semantic feature or group of semantic features, for example in terms of recall or precision. The decoder's input includes a sequential subset of sub-blocks to achieve a particular reconstruction performance and semantic accuracy.

To this end, a multi-head autoencoder model may be used to perform semantic multi-resolution communications. Each head of the autoencoder model may generate a different respective encoded output. The decoder may then take one or more of the encoded outputs together to create a decoded output, with differing levels of quality that depend on the number of encoded outputs it received.

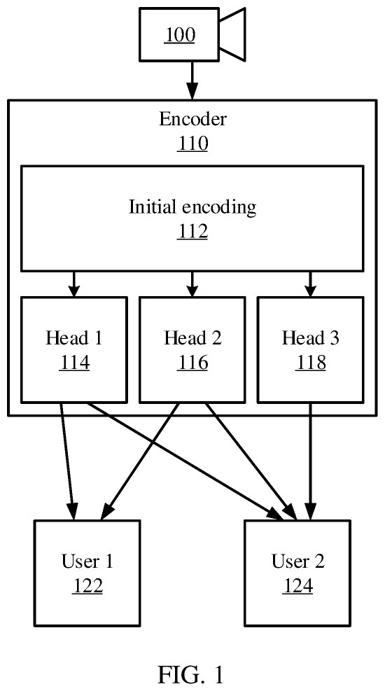

Referring now to FIG. 1, an example of semantic multi-resolution communication is shown. A data source 100 is shown, for example being a video camera that monitors a given environment. The data source 100 generates information, in this case a series of images depicting the environment, and transmits that information to downstream users. Before transmission, the data from the data source 100 is encoded by encoder 110.

The encoder 110 includes multiple stages. An initial encoding 112 processes the raw data from the data source 100 and generates an initial encoding. The initial encoding is then processed by multiple distinct encoder heads, in this example including a first head 114, a second head 116, and a third head 118. Each of the encoder heads performs a respective further encoding of the initial encoding to provide a base encoding and a set of enhancement encodings.

For example, the output of the first head 114 may include the base encoding, while the second head 116 and third head 118 may provide enhancement encodings. In some embodiments, the base encoding may be sufficient to independently decode a relatively low-resolution reconstruction of the original data, while the enhancement encodings may be decoded in conjunction with the base encoding to provide higher-resolution reconstructions of the original data.

A first user 122 and a second user 124 are shown. The first user 122 receives outputs from the first head 114 and the second head 116, while the second user 124 receives outputs from the first head 114, the second head 116, and the third head 118. As a result, decoding the data at the second user 124 will provide superior reconstruction performance as compared to the decoded data at the first user 122.

The channel between the encoder 110 and the first user 122 may differ from the channel between the encoder 110 and the second user 124. In one example these channels may be wireless channels, where channel capacity may be limited by bandwidth constraints, interference from other sources, multipath interference, physical obstructions, and path loss. In another example, the two channels may be wired channels, for example transmitting over optical fiber, ethernet, or other networking media. In such wired channels, channel capacity may be limited by bandwidth constraints, competing traffic, network latency, inter-symbol interference, chromatic dispersion, and polarization mode dispersion. Channels may include a combination of wired and wireless paths, and the channels for the first user 122 and second user 124 may include very different types of and degrees of channel capacity limitations.

The number of signals sent to a given user may therefore be selected in accordance with the limitations of the channel used to communicate with that user. In some cases, users on channels with higher capacities may receive more of the enhancement encodings than users on channels with lower capacities. In addition to consideration of the channel capacities, the decision of what enhancement encodings to send may further include semantic information relating to the data being transmitted.

For example, to minimize bandwidth usage, lower-resolution reconstructed data may be sufficient in normal conditions as long as the semantic information regarding an important event is preserved within the lower-dimensional encoded data. When the receiver detects an important situation, such as a security event in a monitored video stream, higher-resolution data may be needed to identify specific details, such as when facial recognition is needed. In some cases it may be helpful to confirm certain semantic information with a higher confidence, in which case higher-resolution encodings may be provided.

In an exemplary embodiment, the data source 100 may be a video camera at an airport terminal that captures videos of cars, humans, animals, luggage, etc. Video may be encoded with lower resolutions by the first head 114 to preserve bandwidth, while incorporating semantic information that may be needed for running downstream analysis, such as human detection, animal detection, and object detection. Higher-resolution data, for example from the second head 116 and/or third head 118, may be transmitted periodically, randomly, or in response to particular conditions to provide higher-resolution video and/or better accuracy with respect to semantic features. For example, if a downstream analysis task is completed with a low confidence score, additional information may be requested to improve the reconstruction performance and the analysis may be re-run.

Semantic multi-resolution coding generates a block of symbols, also referred to herein as an output or encoded block, for an input message that is represented by an input block of symbols. The encoded block may include L sub-blocks that are indexed sequentially from 1 to L. The decoder at a given user takes the sequence of sub-blocks from 1 to L to generate an output that achieves a particular resolution, which may be determined herein as a combination of a reconstruction performance and a semantic accuracy.

In other words, the (l+1)^{th} sub-block provides differential information to improve the resolution incrementally from the layer/reconstructed output in terms of reconstruction performance and semantic accuracy. The resolution for different output levels may follow a nested structure, such that a well-defined layer (l+1) output has equal or better resolution than the layer/output.

The reconstruction performance for a layer (l+1) can be defined in terms of the semantic content obtained in the layer/output. For example, given a semantic feature preserved in layer/that allows a particular analysis to operate and that is localized in a corresponding region of interest, the reconstruction performance for layer (l+1) may be defined to assign different reconstruction performances for different regions of interest based on their semantic feature types. Thus for an object detection analysis, regions of interest that include objects may be set to a higher reconstruction performance than other regions.

The nested structure makes it possible to define a single accuracy metric at the layer/for a group of classes that belong to a semantic type and then further refine the accuracy in subsequent output levels. A hierarchical structure can be defined for semantic types and classes, such that all possible cases for the layer (l+1) are subsets of the cases defined for layer l. Class pulling may refer to grouping some classes into a single combined class. The hierarchical structure may thereby be defined by allowing class pulling in layer/based on the classes in layer (l+1), having a combined class in layer/by grouping some classes from layer (l+1).

The encoder 110 may therefore include multiple heads in a manner analogous to multi-task learning. In multi-task learning, data used for related tasks may have underlying similarities that can be captured in a common representation. Not only the shared representation, but also individual task performance is improved when such tasks are learned jointly. In that context, a shared pre-layer is used with task-specific layers to perform task-specific functions. The overall loss for the model may be computed during training as a weighted sum of individual task losses, with weights between the task losses being based on relative importances of the tasks.

A multi-resolution autoencoder model aims to efficiently decode data in a hierarchical manner, enabling its decoders to progressively enhance data reconstruction in subsequent levels using the encoded data from previous layers. The multi-head structure of the autoencoder allows a transmitter to encode data to preserve semantic features independently for each layer to facility effective semantic communication.

The transmitted signal may be normalized in each link, so that signal-to-noise ratio of all links are controlled by the variance of the noises zₗᵢ for each link between an encoder head/and a decoder/user i. This signal-to-noise ratio can also be interpreted as the overall signal-to-noise ratio due to the combined effect of channel gain and additive Gaussian noise at the receiver. Based on this interpretation, the encoded output for each head is sent as one packet of transmission and the channel between the encoder 110 and the users may have block fading, where the channel remains constant during transmission of each packet but may change between packets. If the coherence time of the channel covers the entire transmission of the output from all encoder heads, the channel can be modeled as an additive white Gaussian noise (AWGN) channel within the transmission, leading to zₗᵢ=zₗⱼ, ∀i, j∈[L], where L is the set of sub-blocks. Users may be served with different resolutions by transmitting varying numbers of packets, corresponding to different heads.

The autoencoder model can also be used for multi-resolution transmission of data to a single user by setting zₖᵢ=zₗᵢ, ∀k, l∈[L]. In this scenario, the encoded data packet generated by each head of the encoder 110 is successively transmitted to the user to reproduce the data after reception of the first packet, with improvements to its reproduction quality with the receipt of successive packets.

The encoder 110 accepts an input data block x and generates a semantic multi-resolution encoding. An output block generated by the encoder 110 includes L sub-blocks, indexed as l==1, . . . , L, each having nₗ symbols, where 1≤l≤L. The encoder 110 includes a neural network with multiple heads, and the sub-block/is the output of layer l, generated by one of the encoder's heads hₗₖ that belongs to layer l. There are therefore Kₗ possible outputs by layer l for the Kₗ heads of the layer l, each output corresponding to one head k, where 1≤k≤Kₗ.

The encoder performs joint source and channel encoding of the input data x, while the decoders at the users perform both channel and source decoding. The decoder first reconstructs \hat{x} from packets received via the communication channel, and a semantic extractor takes out the semantics ŷ from the reconstructed data. The loss function for each link between an encoder head hₗₖ to a respective user may be expressed as:

$${ℒ}_{lk} = {α}_{lk} {‖ {{\hat{Y}}_{l - 1}}_{} ( x - {\hat{x}}_{lk} ) ‖}^{2} + ( 1 - {α}_{lk} ) ( {T}^{} ( {y}_{lk} ( x ) ) {β}_{lk} log ( σ ( {\hat{y}}_{lk} ) ) )$$

with the first term representing a mean squared error loss or reconstruction loss and the second term representing a semantic loss. The term [symbol] ^{T}(yₗₖ(x)) is a one-hot column vector obtained from the class label yₗₖ(x), βₗₖ is a diagonal matrix that models varying degrees of accuracy for different classes, and o is a softmax operator. The matrix Ýₗ₋₁=[ŷ₁, . . . , ŷₗ₋₁], where ŷₗ=[ŷₗ₁, . . . , ŷ_{l,K}_{ₗ}], ∀l∈[L−1]. A region of interest operator is defined as

$${{\hat{Y}}_{l - 1}}_{} ( x ) = M ⊙ x ,$$

where M is the mask with entries m, 0≤m≤1, that is element-wise multiplied by x. The entries of the mask are used to enforce reconstruction importance of the corresponding element of the input x.

The subscript of [symbol] denotes the possible dependency of the region-of-interest operator to the semantics Yₗ₋₁ extracted by previous layers. For example, the regions of interest may correspond to a segment or bounding box for object detection, which may depend on the semantic extraction output of the previous layer.

The loss function [symbol] ₗₖ may be defined to jointly minimize the reconstruction loss and semantic loss. The value of the parameter αₗₖ is set to prioritize reconstruction loss versus semantic loss. In extreme cases, the priority of the reconstruction loss or semantic loss may be maximized by setting αₗₖ to one or zero. For example, when the first layer is received and indicates an emergency has occurred, the second layer's priority may be to perform facial recognition for actors involved, in which case α₂₁ may be set to equal 1 when designing the encoder head h₂₁, thereby prioritizing the reconstruction loss. Conversely, in the same example, the priority might be to enhance the confidence of a semantic feature of a classifier to be certain that such an emergency has actually occurred before calling emergency services. In that case, the head may be designed by setting α₂₂=0.

The parameters βₗₖ are employed to model the significance of the accuracy of the semantic extraction in identifying different classes. Each element of the diagonal matrix βₗₖ may have a value between zero and one. The selection of different values for the elements of βₗₖ affects recall and precision due to the fact that the cross-entropy term in the semantic loss only tries to maximize the sum of the product of the prior and the posterior probabilities for all classes, which does not correspond to the optimization of either recall or precision. However, a suitable choice for β helps to effectively balance both recall and precision as two different accuracy metrics.

Semantics may include the segmentation or class labels of an input signal. In practical applications, the class labels may follow a hierarchical structure, such as:

$$∀ {c}_{lk} ∈ {C}_{lk} , ∃ {c}_{l - 1 , {k}^{′}} ∈ {C}_{l - 1 , {k}^{′}} : {c}_{lk} ⊂ {c}_{l - 1 , {k}^{′}}$$

where Cₗₖ is the set of class labels for the head k of layer l. The length of the vector ŷₗₖ, [symbol] ^{T}(yₗₖ(x)), and the order of the square matrix βₗₖ is equal to the size of the set Cₗₖ.

A total loss may be defined as the weighted sum of losses calculated across all layers and all heads:

$$ℒ = {\sum }_{l = 1}^{L} {\sum }_{k = 1}^{{K}_{l}} {c}_{lk} {ℒ}_{lk}$$

The sub-block size nₗ and weight cₗₖ may be used to tune the performances for different resolutions or accuracy obtained by different encoder heads or sub-blocks. The training process may benefit from adaptive adjustment of the weights cₗₖ to enforce faster convergence for some encoder heads prior to optimization of the other heads. For example, this approach may be used to design the differential resolution obtained by an encoder head in layer/conditional on a threshold performance by previous layers.

The per-head loss function [symbol] ₗₖ may be used to jointly train an encoder-decoder pair. For faster convergence, and to ensure low semantic loss from the beginning, semantic extractors may be pre-trained with raw data. Alternative optimization may be used to update the semantic extraction after training the encoder-decoder pair in an epoch. As a result, the semantic extraction may be trained to provide the best accuracy based on the reconstructed data, instead of raw data. This incorporates the effect of the designed auto-encoder and channel characteristics.

End-to-end communication systems may be trained to operate within a specific range of channel gains. However, joint source-channel coding is resilient, particularly when channel condition is lower than the trained channel gain. Each encoded data generated by the heads can be sent by different channels. This makes it possible for the decoder to receive its encoded data influenced by varying channel gains. This provides robustness even when different heads transmit their encoded data with different channel gains.

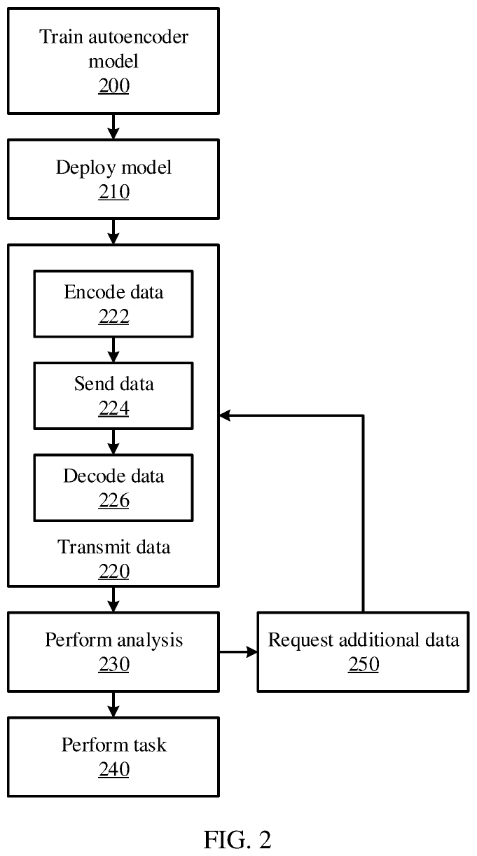

Referring now to FIG. 2, a method of training and using a semantic multi-resolution autoencoder is shown. Block 200 trains the autoencoder model based on a training dataset that includes semantic information. The training considers the transmission of data according to multiple resolutions across channels having different bandwidths and evaluates performance of the model according to reconstruction performance and preservation of the semantic content.

Block 210 then deploys the model. This may include, for example, providing a copy of the autoencoder models at an encoder and at a decoder, including the multiple heads, so that the encoder can appropriately encode new data for transmission and so that the decoder can then reconstruct that new data after reception in block 220.

Block 230 then performs some analysis on the reconstructed data. For example, the analysis may include object detection, person detection, or face recognition. Block 240 performs an action on the basis of the analysis output. For example, the action may include the performance of a security action or summoning emergency services.

Transmission 220 includes encoding data 222 at the encoder 110, sending the data 224 over some channel, and receiving the data 226 at a user. Based on the outcome of the analysis 230, the user may request 250 additional information from the encoder 110, for example by requesting blocks output by one or more additional heads. Sending the data 224 may target a single user or multiple users, and each user may have a variable number of sub-blocks transmitted to them. The transmission of data 220 may be performed by a single entity that controls the encoder 110 as well as the decoder(s), or may be performed by multiple entities.

Exemplary training datasets include the modified National Institute of Standards and Technology (MNIST) database of handwritten digits and the Canadian Institute for Advanced Research (CIFAR)-10 dataset of classified images. These datasets are made up of pixel information that encodes semantic information (e.g., a depicted number or a particular object). Any appropriate source and channel coding scheme may be used, for example using the better portable graphics (BPG) scheme for source coding and low-density parity-check (LDPC) codes for channel coding.

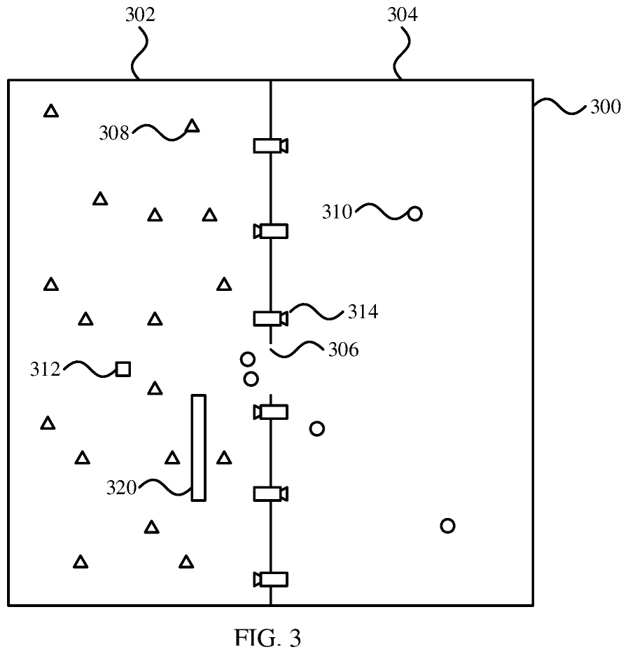

Referring now to FIG. 3, an environment 300 is shown. For example, one type of environment that is contemplated is a mall or shopping center, which may include a common space 302 and one or more regions 304, such as a store. It should be understood that this example is provided solely for the purpose of illustration, and should not be regarded as limiting.

A boundary is shown between the common space 302 and the region 304. The boundary can be any appropriate physical or virtual boundary. Examples of physical boundaries include walls and rope—anything that establishes a physical barrier to passage from one region to the other. Examples of virtual boundaries include a painted line and a designation within a map of the environment 300. Virtual boundaries do not establish a physical barrier to movement, but can nonetheless be used to identify regions within the environment. For example, a region of interest may be established next to an exhibit or display, and can be used to indicate people's interest in that display. A gate 306 is shown as a passageway through the boundary, where individuals are permitted to pass between the common space 302 and the region 304.

The environment 300 is monitored by a number of video cameras 314. Although this embodiment shows the cameras 314 being positioned at the gate 306, it should be understood that such cameras can be positioned anywhere within the common space 302 and the region 304. The video cameras 314 capture live streaming video of the individuals in the environment. A number of individuals are shown, including untracked individuals 308, shown as triangles, and tracked individuals 310, shown as circles. Also shown is a tracked person of interest 312, shown as a square. In some examples, all of the individuals may be tracked individuals. In some examples, the tracked person of interest 312 may be tracked to provide an interactive experience, with their motion through the environment 300 being used to trigger responses.

In addition to capturing visual information, the cameras 314 may capture other types of data. For example, the cameras 314 may be equipped with infrared sensors that can read the body temperature of an individual. In association with the visual information, this can provide the ability to remotely identify individuals who are sick, and to track their motion through the environment.

The environment 300 may include occlusions 320. For example, fixed occlusions may include walls, staircases, escalators, and other barriers. Movable occlusions may include people, signage, vehicles, and other objects that may make up a dynamic environment. The occlusions 320 may prevent individuals from being visible from certain angles and to certain cameras 314. Thus a person who is visible from one camera may not be visible to another camera, even if their visual ranges otherwise overlap.

Visual and location information may be collected for each tracked person 310 using frames from the video cameras 314. The frames from respective video streams may be synchronized in time, so that different views of the environment 300 may be compared to one another for given points in time.

In the context of this environment, the cameras 314 may communicate wirelessly with a security station, which collects the various video streams and performs analysis. One exemplary type of analysis is to recognize and track persons of interest 312 through the environment and to detect particular actions performed by those persons of interest 312. For example, the person of interest 312 may enter a forbidden area, may interact with an object in a dangerous fashion, or may show signs of distress.

Because the cameras 314 may have limited bandwidth, they may perform multi-resolution encoding to manage how much data they send. The security station may respond to the results of its analysis by requesting additional data, for example by requesting additional resolution for the entire scene or for a particular region of interest.

The security station may trigger any of a variety of responsive actions. For example, the responsive action may include a security action, such as locking or unlocking a door, permitting or denying access, summoning alerting security personnel. The responsive action may be performed automatically upon detection that the transmitted data satisfies a particular semantic criterion. For example, if the individual is tracked in a place where they are not authorized access, a security action may be automatically triggered. If the individual's movements indicate a negative health event, a healthcare response may be automatically triggered.

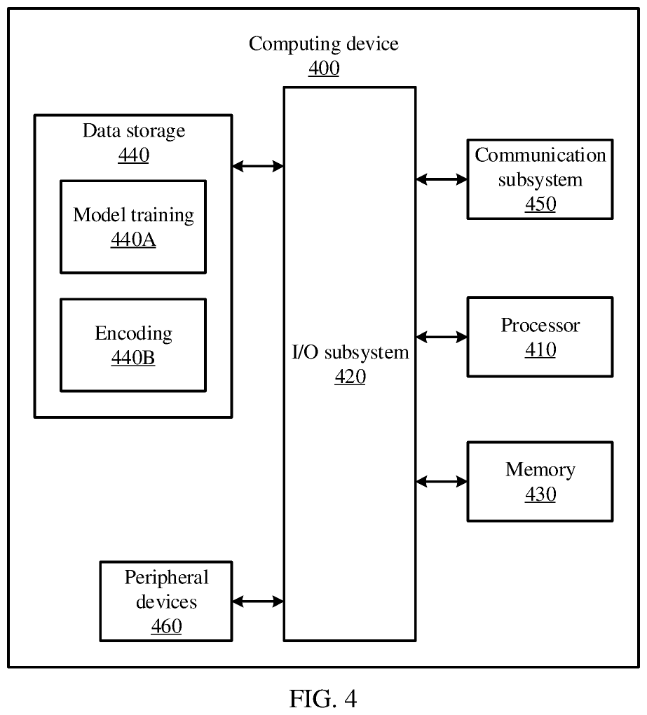

Referring now to FIG. 4, an exemplary computing device 400 is shown, in accordance with an embodiment of the present invention. The computing device 400 is configured to track movement across multiple cameras.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for training the model and 440B for encoding data. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

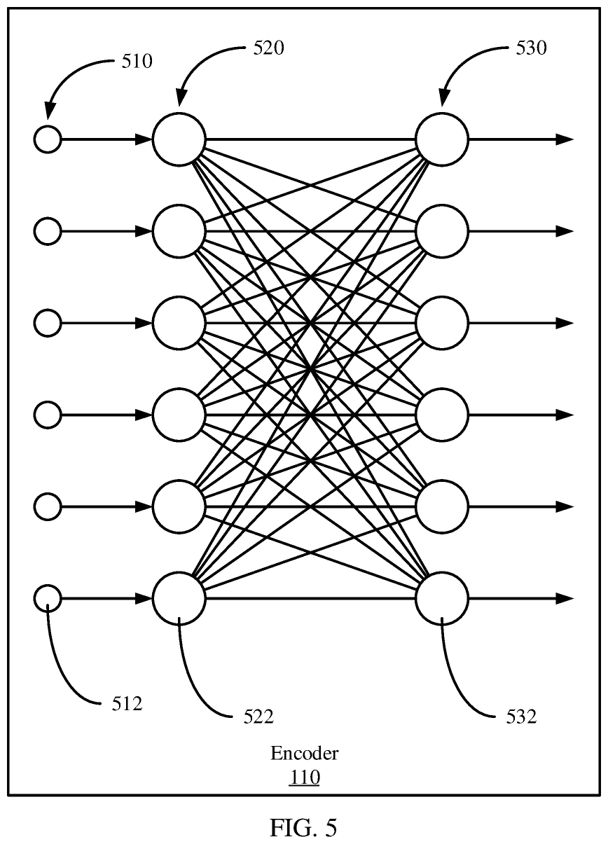

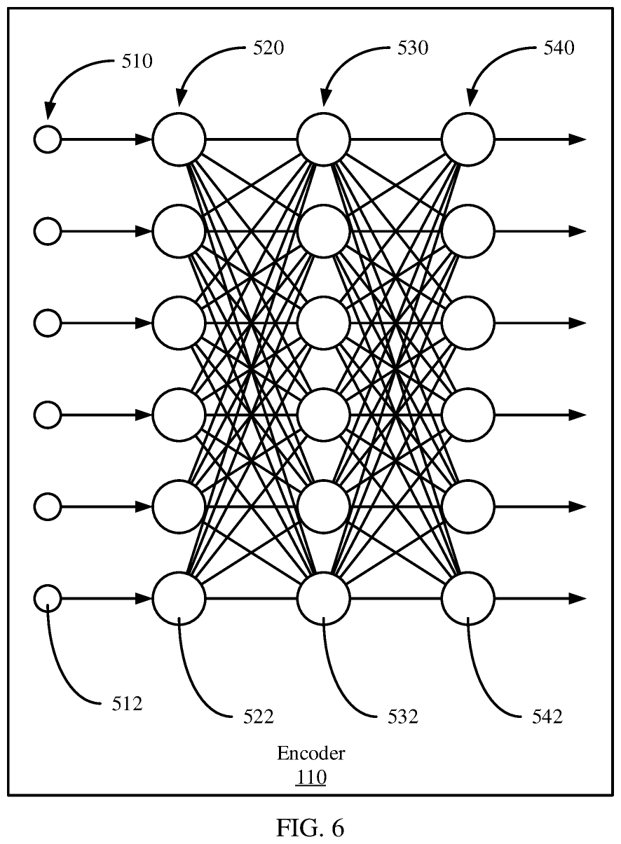

Referring now to FIGS. 5 and 6, exemplary neural network architectures are shown, which may be used to implement parts of the present models, such as the encoder 110. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for semantic multi-resolution transmission, comprising:
encoding data using an encoder model that includes an initial encoding and a plurality of heads, where a first head of the plurality of heads outputs a base encoding and a remainder of the plurality of heads output respective enhancement encodings;
decoding the base encoding and at least one of the enhancement encodings using a decoder model to retrieve a semantic meaning of the data and to generate a reconstructed output; and
performing a task responsive to the reconstructed output and retrieved semantic meaning.

2. The method of claim 1, further comprising requesting an additional enhancement encoding responsive to the reconstructed output.

3. The method of claim 2, wherein the additional enhancement encoding is requested to improve reconstruction performance of the reconstructed output.

4. The method of claim 2, wherein the additional enhancement encoding is requested to improve confidence in a semantic feature of the reconstructed output.

5. The method of claim 2, wherein the additional enhancement encoding is requested responsive to an identification of a predetermined semantic feature of the reconstructed output.

6. The method of claim 1, further comprising training the encoder model and the decoder model using an objective function that includes a reconstruction loss and a semantic loss.

7. The method of claim 6, wherein the reconstruction loss is computed over a region of interest operator which is determined based on the semantic meaning.

8. The method of claim 6, wherein the objective function is:
$${ℒ}_{lk} = {α}_{lk} {‖ {{\hat{Y}}_{l - 1}}_{} ( x - {\hat{x}}_{lk} ) ‖}^{2} + ( 1 - {α}_{lk} ) ( {T}^{} ( {y}_{lk} ( x ) ) {β}_{lk} log ( σ ( {\hat{y}}_{lk} ) ) )$$
where αₗₖ is a weighting parameter, [symbol] is a region of interest operator for semantics Ŷᵢ₋₁, x is an input data block, \hat{x}ₗₖ is a reconstructed data block, term [symbol] ^{T}(yₗₖ(x) is a one-hot column vector obtained from the class label yₗₖ(x), βₗₖ is a diagonal matrix that models varying degrees of accuracy for different classes, and σ is a softmax operator.

9. The method of claim 1, further comprising transmitting the base encoding and at least one of the enhancement encodings from a data source to a destination, with selection of the at least one of the enhancement encodings being based on channel properties between the data source and the destination.

10. The method of claim 1, wherein the task includes a security action selected from the group consisting of locking or unlocking a door, permitting or denying access, and summoning alerting security personnel.

11. A system for semantic multi-resolution transmission, comprising:
a hardware processor; and
a memory that stores a computer program which, when encoded by the hardware processor, causes the hardware processor to:
encode data using an encoder model that includes an initial encoding and a plurality of heads, where a first head of the plurality of heads outputs a base encoding and a remainder of the plurality of heads output respective enhancement encodings;
decode the base encoding and at least one of the enhancement encodings using a decoder model to retrieve a semantic meaning of the data and to generate a reconstructed output; and
perform a task responsive to the reconstructed output and retrieved semantic meaning.

12. The system of claim 11, wherein the computer program further causes the hardware processor to request an additional enhancement encoding responsive to the reconstructed output.

13. The system of claim 12, wherein the additional enhancement encoding is requested to improve reconstruction performance of the reconstructed output.

14. The system of claim 12, wherein the additional enhancement encoding is requested to improve confidence in a semantic feature of the reconstructed output.

15. The system of claim 12, wherein the additional enhancement encoding is requested responsive to an identification of a predetermined semantic feature of the reconstructed output.

16. The system of claim 11, wherein the computer program further causes the hardware processor to train the encoder model and the decoder model using an objective function that includes a reconstruction loss and a semantic loss.

17. The system of claim 16, wherein the reconstruction loss is computed over a region of interest operator which is determined based on the semantic meaning.

18. The system of claim 16, wherein the objective function is:
$${ℒ}_{lk} = {α}_{lk} {‖ {{\hat{Y}}_{l - 1}}_{} ( x - {\hat{x}}_{lk} ) ‖}^{2} + ( 1 - {α}_{lk} ) ( {T}^{} ( {y}_{lk} ( x ) ) {β}_{lk} log ( σ ( {\hat{y}}_{lk} ) ) )$$
where αₗₖ is a weighting parameter, [symbol] is a region of interest operator for semantics Ŷᵢ₋₁, x is an input data block, \hat{x}ₗₖ is a reconstructed data block, term [symbol] ^{T}(yₗₖ(x)) is a one-hot column vector obtained from the class label yₗₖ(x), βₗₖ is a diagonal matrix that models varying degrees of accuracy for different classes, and σ is a softmax operator.

19. The system of claim 11, wherein the computer program further causes the hardware processor to transmit the base encoding and at least one of the enhancement encodings from a data source to a destination, with selection of the at least one of the enhancement encodings being based on channel properties between the data source and the destination.

20. The system of claim 11, wherein the task includes a security action selected from the group consisting of locking or unlocking a door, permitting or denying access, and summoning alerting security personnel.
